(19) United States
(12) Patent Application Publication
(10) Pub. No.: US 2014/0172562 A1
(43) Pub. Date: Jun. 19, 2014

(54) QUERY-REFINEMENT ADVERTISEMENTS BASED ON QUERY-COMPLETION SUGGESTIONS

(71) Applicant: MICROSOFT CORPORATION, Redmond, WA (US)

(72) Inventor: STEPHEN MORRIS WEATHERFORD, BOTHELL, WA (US)

(73) Assignee: MICROSOFT CORPORATION, REDMOND, WA (US)

(21) Appl. No.: 13/713,168

(22) Filed: Dec. 13, 2012

(51) Int. Cl. G06Q 30/02

(52) U.S. Cl. CPC G06Q 30/0256
USPC 705/14.54

(57) ABSTRACT

Methods, computer systems, and computer storage media are provided for presenting query-refinement advertisements based on query-completion suggestions. At least a portion of a search query is received, and one or more query-completion suggestions are provided. An indication of interaction with at least one of the query-completion suggestions is received. Based on the interaction, a query-refinement advertisement is provided.

### BACKGROUND

One way for a search service or a third-party application or “app” to monetize its services is to sell online advertising space to advertisers or third-parties. The search service or app receives revenue from the advertisers when an advertisement is displayed on a results page and/or when a user selects or clicks on the displayed advertisement. Thus, a goal for any search service and/or app is to present relevant advertisements on a frequent basis to users in such a way that that there is an increased likelihood that the users will interact with the advertisements. However, typical user search behavior does not always lead to this result. For instance, a usual pattern for a user wishing to buy or research a product is to access a search service, input a search query relating to the product, and peruse the resulting search results including the online advertisements that are presented in conjunction with the search results. The user may spend a significant amount of time viewing the often overwhelming number of search results and/or advertisements to try and locate the right product. In many instances, the user simply gives up before selecting a result which, in turn, results in a loss of a monetizing event for the search service. In other cases, the user ends up selecting a result that navigates the user away from the search service without ever generating a monetizing event.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-storage media for, among other things, providing query-refinement advertisements to a user based on the user interacting with a query-completion suggestion provided for an inputted search query. At a high level, a user inputs at least a portion of a search query and query-completion suggestions corresponding to the search query are presented. Incident to the user interacting with one of the query-completion suggestions, a query-refinement advertisement is presented to the user. The query-refinement advertisement is selected based on, among other things, attributes of the query-completion suggestion and may include query-refinement suggestions and/or links that help the user to further refine his or her search. As well, the query-refinement advertisement may include selectable actions. The query-refinement advertisement is presented to the user before search results are shown which increases the likelihood of user engagement with the advertisement. As well, the query-refinement advertisement is presented in an area of the display screen associated with or adjacent to the inputted query which also increases the likelihood of user interaction. Selection of the query-refinement advertisement, or a query-refinement suggestion, link, and/or action within the advertisement navigates the user to a landing page that addresses the user's intent; again, this can occur without a search ever having been executed. The result is improved monetization opportunities for the search service and/or app and increased user satisfaction because of the refinement opportunities and action opportunities provided by the query-refinement advertisement.

Accordingly, in one embodiment, the present invention is directed to one or more computer-storage media having computer-executable instructions embodied thereon that, when executed by a computing device, cause the computing device to perform a method of providing query-refinement advertisements based on query-completion suggestions. The method comprises receiving at least a portion of a search query and providing one or more query-completion suggestions based on the at least the portion of the search query. An indication of interaction with a first query-completion suggestion of the one or more query-completion suggestions is received. In response to the interaction with the first query-completion suggestion, a first query-refinement advertisement that is relevant to the first query-completion suggestion is provided.

In another embodiment, the present invention is directed to a computer system for performing a method of providing query-refinement advertisements based on query-completion suggestions. The system comprises a computing device associated with an advertisement search service having one or more processors and one or more computer-storage media, and a data store coupled with the advertisement search service. The advertisement search service receives at least a portion of a search query in association with a query-input region of a screen display and provides at least one query-completion suggestion in association with the query-input region. The at least one query-completion suggestion is based on the at least the portion of the search query. The advertisement search service receives an indication of interaction with the at least one query-completion suggestion, and based on the interaction, provides a query-refinement advertisement in association with the query-input region. The query-refinement advertisement is relevant to the at least one query-completion suggestion.

In yet another embodiment, the present invention is directed to a computerized method carried out by advertisement search service having at least one processor for providing query-refinement advertisements relevant to query-completion suggestions. The method comprises receiving at least a portion of a search query in association with a query-input region, and presenting at least one query-completion suggestion in association with the query-input region. The at least one query-completion suggestion is based on the at least the portion of the search query. An indication of interaction with the at least one query-completion suggestion is received and at least one query-refinement advertisement is selected. The at least one query-refinement advertisement is presented in association with the query-input region and comprises one or more query refinement suggestions relevant to the at least one query-completion suggestion.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system for providing query-refinement advertisements based on query-completion suggestions suitable for use in implementing embodiments of the present invention;

FIG. 3-8 depict exemplary graphical user interfaces that illustrate the presentation of query-refinement advertisements in association with query-completion suggestions in accordance with embodiments of the present invention;

FIGS. 9A-9B depict exemplary graphical user interfaces that illustrate the presentation of targeted advertisements in association with a query-input region in accordance with embodiments of the present invention; and

FIGS. 10-11 depict flow diagrams of exemplary methods of providing query-refinement advertisements based on query-completion suggestions in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer storage media for, among other things, providing query-refinement advertisements to a user based on the user interacting with a query-completion suggestion provided for an inputted search query. At a high level, a user inputs at least a portion of a search query and query-completion suggestions corresponding to the search query are presented. Incident to the user interacting with one of the query-completion suggestions, a query-refinement advertisement is presented to the user. The query-refinement advertisement is selected based on, among other things, attributes of the query-completion suggestion and may include query-refinement suggestions and/or links that help the user to further refine his or her search. As well, the query-refinement advertisement may include selectable actions. The query-refinement advertisement is presented to the user before search results are shown which increases the likelihood of user engagement with the advertisement. As well, the query-refinement advertisement is presented in an area of the display screen associated with or adjacent to the inputted query which also increases the likelihood of user interaction. Selection of the query-refinement advertisement, or a query-refinement suggestion, link, and/or action within the advertisement, navigates the user to a landing page that addresses the user's intent; this occurs without a search ever needing to be executed. The result is improved monetization opportunities for the search service and/or app and increased user satisfaction because of the refinement opportunities and action opportunities provided by the query-refinement advertisement.

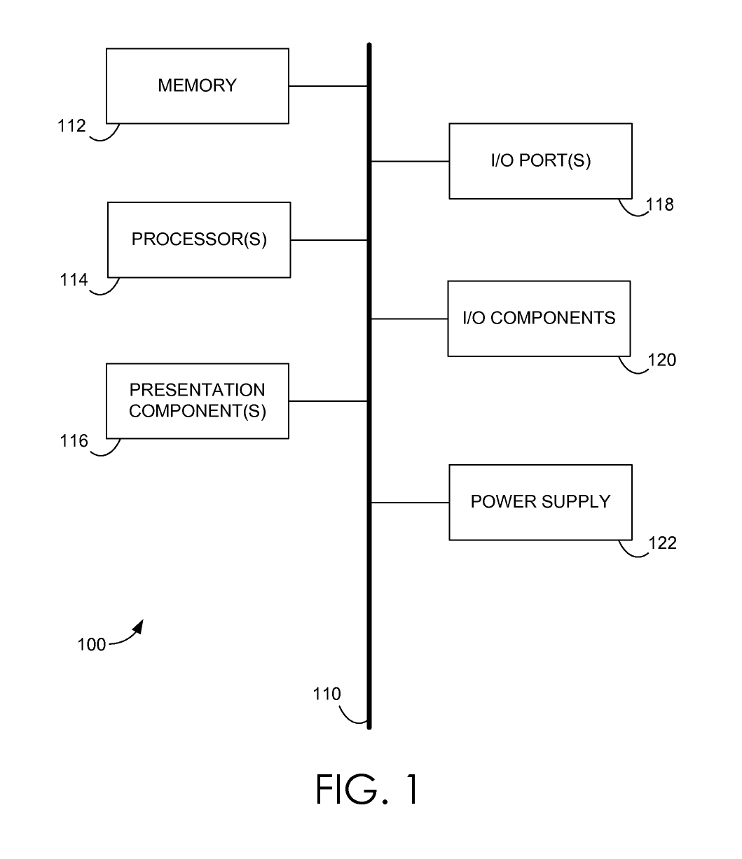

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the invention may be described in the general context of computer code or machine-useable instructions, including computer-useable or computer-executable instructions such as program modules, being executed by a computer or other machine, such as a personal data assistant, a smart phone, a tablet PC, or other handheld device. Generally, program modules including routines, programs, objects, components, data structures, and the like, refer to code that performs particular tasks or implements particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network. In a distributed computing environment, program modules may be located in both local and remote computer storage media including memory storage devices.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media; computer storage media excludes signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, joystick, game pad, satellite dish, scanner, printer, wireless device, and the like.

Furthermore, although the term “server” is often used herein, it will be recognized that this term may also encompass a search engine, an advertisement search service, a Web browser, a cloud server, a set of one or more processes distributed on one or more computers, one or more stand-alone storage devices, a set of one or more other computing or storage devices, a combination of one or more of the above, and the like.

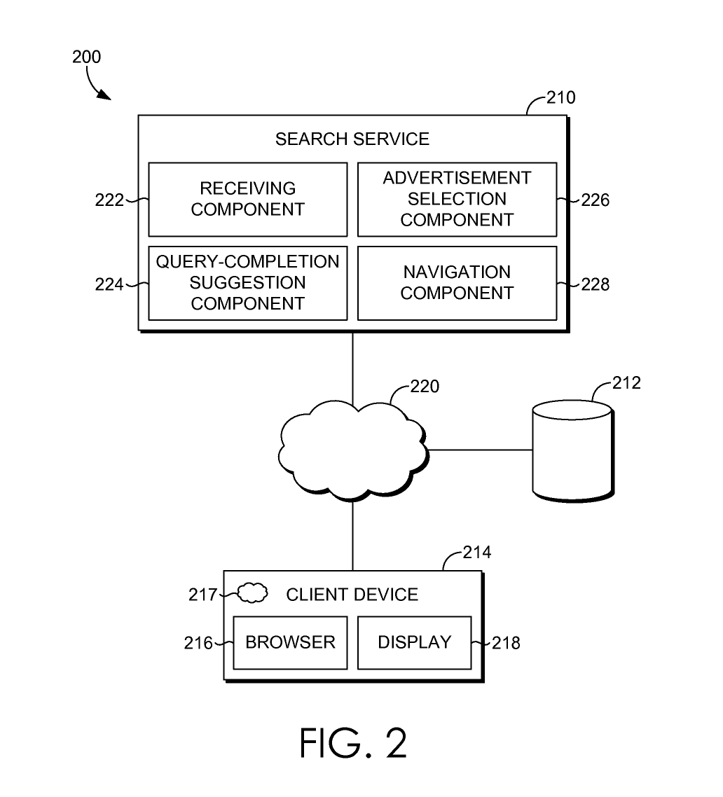

Referring now to FIG. 2, a block diagram is provided illustrating an exemplary computing system 200 in which embodiments of the present invention may be employed. Generally, the computing system 200 illustrates an environment in which query-refinement advertisements are provided based on query-completion suggestions presented in response to an inputted search query. The query-refinement advertisements assist the user in further refining his or her search intent and additionally provide opportunities for the user to fulfill his or her purchasing intent without ever needing to execute a search based on the inputted search query. In one aspect, the query-refinement advertisements are presented in an area of the display screen that is easily viewable by the user. Additionally, the query-refinement advertisements may be presented before search results are shown which further increases the likelihood of user engagement with the advertisement.

Among other components not shown, the computing system 200 generally includes an advertisement search service 210, its associated data store 212, and a client device 214, all in communication with one another via a network 220. The network 220 may include, without limitation, one or more local area networks (LANs) and/or wide area networks (WANs). Such networking environments are commonplace in offices, enterprise-wide computer networks, intranets and the Internet. Accordingly, the network 220 is not further described herein.

It should be understood that any number of client computing devices and advertisement search services may be employed in the computing system 200 within the scope of embodiments of the present invention. Each may comprise a single device/interface or multiple devices/interfaces cooperating in a distributed environment. For instance, the advertisement search service 210 may comprise multiple devices and/or modules arranged in a distributed environment that collectively provide the functionality of the advertisement search service 210 described herein. Additionally, other components/modules not shown also may be included within the computing system 200.

In some embodiments, one or more of the illustrated components/modules may be implemented as stand-alone applications. In other embodiments, one or more of the illustrated components/modules may be implemented via the client device 214, as an Internet-based service, as a third-party application service, or as a module inside the advertisement search service 210. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of search services, third-party applications, or client computing devices. By way of example only, the advertisement search service 210 might be provided as a single server (as shown), a cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The client computing device 214 may include any type of computing device, such as the computing device 100 described with reference to FIG. 1, for example. Generally, the client computing device 214 may include a browser 216, one or more third-party applications 217, and a display 218. The browser 216, among other things, is configured to render search home pages (or other online landing pages), and render search results pages (SRPs) in association with the display 218 of the client computing device 214. The browser 216 is further configured to receive user input of requests for various Web pages (including search home pages and results pages), receive user-inputted search queries (generally inputted via a user interface presented on the display 218 and permitting alpha-numeric and/or textual input, voice input, and/or gesture input into a designated search box), and to receive content for presentation on the display 218, for instance, from the advertisement search service 210. The browser 216 may be any suitable type of Web browser such as Internet Explorer®, Firefox®, Chrome®, Safari®, or other type of software configured to enable submission of search queries as disclosed herein. It should be noted that the functionality described herein as being performed by the browser 216 may be performed by any other application capable of rendering Web content. Any and all such variations, and any combination thereof, are contemplated to be within the scope of embodiments of the present invention.

The third-party application 217 (otherwise known by the term “app”) broadly pertains to application software designed to be executed by an operating system hosted on a computing device, a remote cloud-based server, or a combination of both; the application software assists the user in performing specific tasks. In operation, applications provide digital solutions in the real world, such as word processing, gaming, communication-based interfaces, etc. Examples of applications include enterprise software, accounting software, office suites, graphics software, and media players and include such popular applications as GROUPON®, SHAZAM®, OPENTABLE®, YELP®, and the like. It should be understood and appreciated that the definition of applications is not limited to the scope of examples provided herein and may include any code that carries out one or more operations when executed.

The third-party application 217, among other things, is configured to render application home pages as well as application result pages in association with the display 218 of the client computing device 214. The third-party application 217 is further configured to receive user input of requests for various application pages (including home pages and results pages), receive user-inputted search queries (generally inputted via a user interface presented on the display 218 and permitting alpha-numeric and/or textual input, voice input, and/or gesture input into a designated search box), and to receive content for presentation on the display 218, for instance, from the advertisement search service 210.

The display 218 is configured to present various content including, without limitation, browser home pages, search engine home pages, and/or third-party application pages having a query-input region, query-completion suggestions (for instance, in association with a query-input region), query-refinement advertisements, and results pages, as described herein. As used throughout this application, the term “results page” is meant to encompass Web pages such as search engine results pages, and result pages associated with search-type applications, either standalone or embedded in other applications (e.g., Xbox®, Microsoft® Office, and the like). In embodiments, the display 218 is further configured to enable touch inputs, auditory inputs, and/or gesture inputs from a user.

The advertisement search service 210 is configured to receive and respond to requests that it receives from components associated with client computing devices, for instance, the browser 216, and/or the third-party application 217 associated with the client computing device 214. Those skilled in the art of the present invention will recognize that the present invention may be implemented with any number of searching utilities. For example, an Internet search engine or service, a database search engine, and/or a third-party search application may utilize the present invention. These searching utilities are well known in the art, and commercially available searching utilities share many similar processes not further described herein.

As illustrated, the advertisement search service 210 includes a receiving component 222, a query-completion suggestion component 224, an advertisement-selection component 226, and a navigation component 228. In some embodiments, one or more of the components 222, 224, 226, and 228 may be implemented as stand-alone applications. In other embodiments, one or more of the components 222, 224, 226, and 228 may be integrated directly into the operating system of a computing device such as the computing device 100 of FIG. 1 or the client device 214. It will be understood that the components 222, 224, 226, and 228 illustrated in FIG. 2 are exemplary in nature and in number and should not be construed as limiting. Any number of components may be employed to achieve the desired functionality within the scope of embodiments hereof.

The illustrated advertisement search service 210 also has access to the data store 212. The data store 212 is configured to store information for use by, for example, the advertisement search service 210. The information stored in association with the data store 212 is configured to be searchable for one or more items of information stored in association therewith. The information stored in association with the data store 212 may comprise general information used by the advertisement search service 210. For example, the data store 212 may store information concerning recorded search behavior of users in general, and, when permitted, a log of a particular user's search behavior. The data store 212 may also store cached search results corresponding to search queries, query-completion suggestions for one or more search queries, and advertisements. The advertisements may include query-refinement advertisements as well as non-query refinement advertisements that are supplied by third-parties. The third-parties, in turn, may comprise companies that sell products or services, or third-party agencies that work in conjunction with companies to promote the sale of the products or services.

The content and volume of such information in the data store 212 are not intended to limit the scope of embodiments of the present invention in any way. Further, though illustrated as a single, independent component, the data store 212 may, in fact, be a plurality of storage devices, for instance, a database cluster, portions of which may reside on the advertisement search service 210, the client device 214, and/or any combination thereof.

The receiving component 222 of the advertisement search service 210 is configured to receive a variety of inputs including search queries or portions of search queries inputted via, for example, the display 218 of the client device 214. As used throughout this application, the term “search query” or “portion of a search query” encompasses one or more inputted characters, letters, words, terms, phrases, and the like. The receiving component 222 is further configured to receive indications that a user is interacting with, for example, query-completion suggestions. Interactions may include selecting or clicking a query-completion suggestion, hovering over a query-completion suggestion, or placing a cursor over a query-completion suggestion. Other interactions with a query-completion suggestion may include touch gestures such as tapping, swiping, sliding, pinching, drawing a line under or a circle around the query-completion suggestion, and other multi-touch gestures known in the art. Any and all such variations, and any combination thereof, are contemplated to be within the scope of embodiments of the present invention.

The query-completion suggestion component 224 is configured to present one or more query-completion suggestions in response to a received search query. The query-completion suggestions may be cached suggestions stored in association with, for example, the data store 212. As well, the query-completion suggestions may be determined on-the-fly using methods known in the art. Any and all such variations, and any combination thereof, are contemplated to be within the scope of embodiments of the present invention. The query-completion suggestions are presented in association with a search query-input region associated with, for example, the display 218 of the client device 214.

The query-completion suggestion component 224 is further configured, using methods known in the art, to dynamically update the query-completion suggestions as additional search query input is received. By way of illustrative example, query-completion suggestions corresponding to a partial search query of “what is the best” may include “what is the best cell phone,” and “what is the best laptop.” In response to the user continuing to add characters or terms to the search query, the query-completion suggestions are updated. Using the example provided, in response to the updated search query “what is the best app for,” query completion suggestions may include “what is the best app for ipod touch,” and “what is the best app for weight loss.”

The advertisement-selection component 226 is configured to select and present one or more query-refinement advertisements based on, for example, the receipt of an indication that a user is interacting with a query-completion suggestion. The query-refinement advertisements may be sponsored advertisements provided by one or more third-parties. The query-refinement advertisements may be stored in association with a data store such as the data store 212.

The advertisement-selection component 226 may select a query-refinement advertisement by identifying one or more keywords and/or phrases in the query-completion suggestion and selecting the advertisement based on the identified keywords and/or phrases. In one aspect, the third-party that provides the advertisement specifies the keywords and phrases in search queries and/or query-completion suggestions necessary to invoke the presentation of the advertisement.

The advertisement-selection component 226 may further select a query-refinement advertisement based on demographic features, such as geographic location of the user, known to the advertisement search service 210. For instance, users in the United States may be known to prefer certain cell phone carriers such as Verizon®, while users in Europe may prefer carriers such as TMobile® or Virgin®. Advertisements may also be further selected based on recent searches cached by the browser, search service, or third-party application. For example, recent searches may indicate user interest in certain brand of clothing; query-refinement advertisements directed to this brand may be selected and presented based on interaction with a query-completion suggestion dealing with clothing.

As well, the advertisement-selection component 226 may select advertisements based on the operating system associated with the client device 214. Users of certain operating systems or browsers may be known to prefer certain technology brands. By way of example, users of Safari® Internet browser may prefer Apple® brands, while users of Internet Explorer® may prefer Windows® brands. Additional selection factors may be available when users are logged into their search engine accounts or third-party applications (e.g., the third-party application 217). In this case, the advertisement-selection component 226 may utilize user profile information, and/or social network information to aid in the selection of a query-refinement advertisement. Any and all such variations, and any combination thereof, are contemplated to be within the scope of embodiments of the present invention.

The query-refinement advertisements selected by the advertisement-selection component 226 may include refinement links and suggestions that further refine the associated query-completion suggestion as well as actions that are relevant to the query-completion suggestion. This will be discussed in greater depth below. The selected query-refinement advertisement is presented in association with the query-input region on a display screen such as the display 218 of the client device 214.

Upon receiving an indication that a user is interacting with a second query-completion suggestion provided in response to the inputted search query, the advertisement-selection component 226 identifies a second query-refinement advertisement and presents the advertisement in association with the query-input region. In one aspect, once the indication is received that the user is interacting with the second query-completion suggestion, the query-refinement advertisement associated with the first query-completion suggestion is no longer presented or provided. In this way, one query-refinement advertisement is presented at a time which helps to attract and focus the user's attention.

The navigation component 228 is configured to navigate to landing pages upon receiving a selection of, for example, a query-refinement advertisement or a query-refinement suggestion associated with a query-refinement advertisement. The landing pages may comprise Web pages sponsored by the company that provides the query-refinement advertisement; the Web pages are structured to meet user intent as shown by the selected query-refinement suggestion. The landing pages may also comprise application pages, including sponsored application pages, that meet user intent. For instance, selection of a query-refinement suggestion directed to “best Windows phone” would direct the user to a company-sponsored Web page that provides information and/or purchasing options for highly-rated Windows phones.

Additionally, the navigation component 228 is configured to initiate one or more actions associated with query-refinement advertisements. Query-refinement advertisements may include one or more selectable actions that are relevant to the associated query-completion suggestion and are designed to meet user intent. The actions may be initiated by navigating the user to a landing page such as a Web page or application page that enables the user to initiate the action. As well, actions may be automatically initiated directly from the query-refinement advertisement without requiring user intervention and without navigating away from the search page. By way of illustrative example, interaction with a query-completion suggestion “hunger games trailer” provided in response to the search query “hunger games,” initiates the presentation of a query-refinement advertisement supplied by Fandango®. The advertisement may include a selectable action that enables the user to directly view the movie trailer without navigating away from the search page. The user's selection of an action may satisfy the user's intent without a search ever needing to be executed.

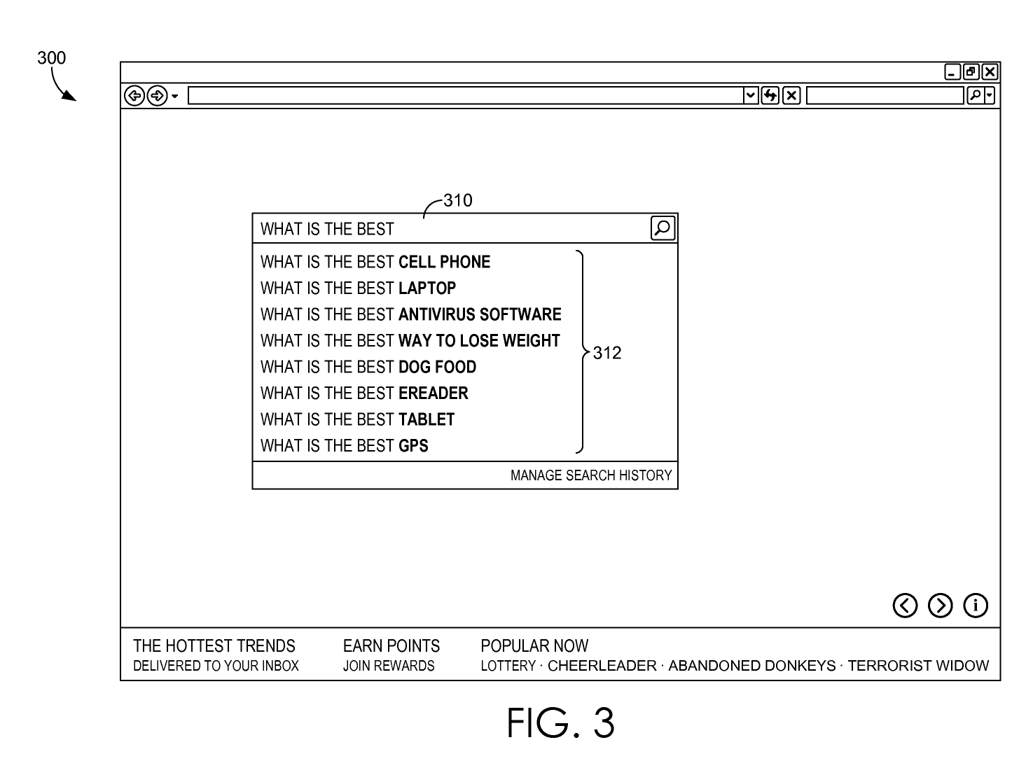

Turning now to FIGS. 3-7, a series of exemplary graphical user interfaces (GUIs) are provided that illustrate the presentation of exemplary query-refinement advertisements. FIG. 3 illustrates a search page 300 that includes a query-input region 310 with the search query “what is the best,” and a set of query-completion suggestions 312 provided in response to the inputted search query and presented in association with or adjacent to the query-input region 310. As mentioned above, the set of query-completion suggestions 312 are determined using methods known in the art. The search page 300 may be a search engine home page, a page associated with an Internet browser, and/or a page associated with a third-party application. Any and all such variations, and any combination thereof, are contemplated to be within the scope of embodiments of the present invention.

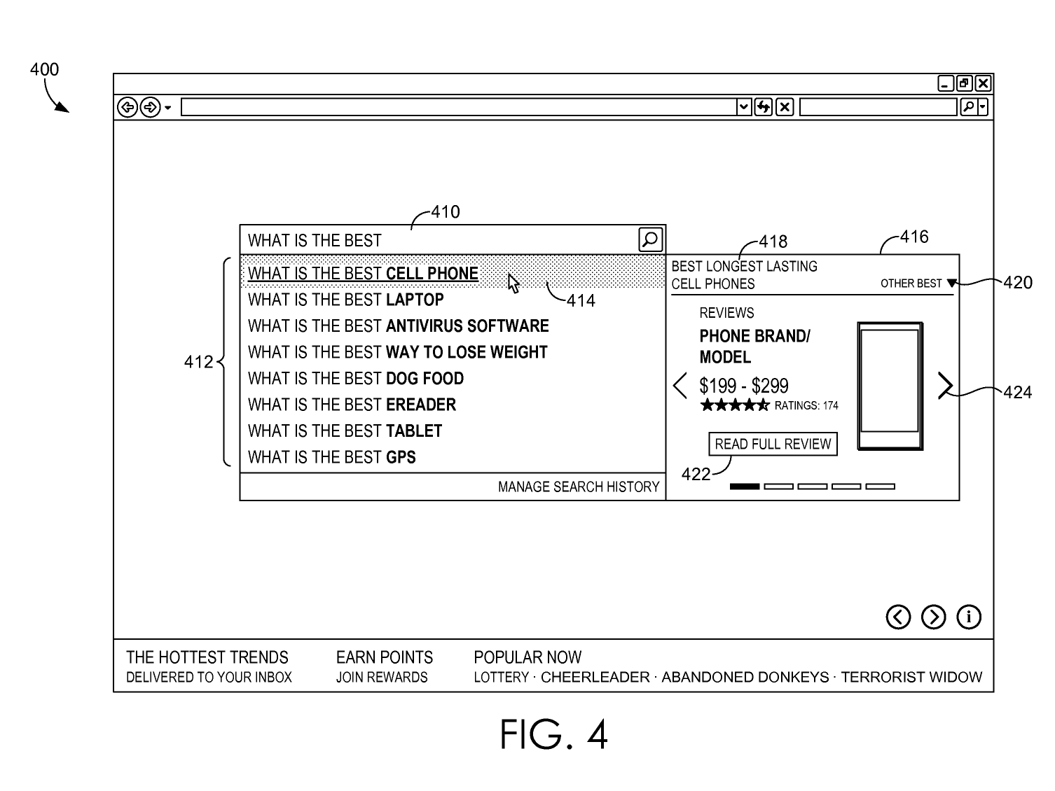

FIG. 4 illustrates the search page 300 (now labeled as search page 400) at a slightly later point in time. The search page includes query-input region 410 corresponding to the query-input region 310 of FIG. 3, and a set of query-completion suggestions 412 corresponding to the set of query-completion suggestions 312 of FIG. 3. As shown, a user is interacting with query-completion suggestion 414. Interactions may include selecting the query-completion suggestion 414, hovering over or placing a cursor on the query-completion suggestion 414, and/or selecting or interacting with the query-completion suggestion 414 by executing one or more gestures such as tapping, sliding, swiping, and the like.

In response to the interaction with the query-completion suggestion 414, a query-refinement advertisement 416 is presented in association with or adjacent to the query-input region 410. The query-refinement advertisement 416 is relevant to the query-completion suggestion 414. For instance, the query-completion suggestion 41 is directed to cell phones and the query-refinement advertisement 416 is directed to cell phones.

Besides including content such as product descriptions, images, ratings, and the like, the query-refinement advertisement 416 includes a first query-refinement suggestion 418 as well as an option 420 to view additional query-refinement suggestions as a drop-down list. The first query-refinement suggestion 418 is related to and further refines the query-completion suggestion 414. The query-refinement advertisement 416 also includes an option 424 to view additional products that meet the criteria associated with the first query-refinement suggestion 418. Continuing, a selectable action 422 (e.g., “Read full review”) is also shown. Selection of the action 422 may initiate the presentation of the review on the search page 400 or may navigate the user to a landing page that presents the review. In one aspect, the content associated with the query-refinement advertisement 416 is provided by the company that supplies the advertisement 416. In another aspect, the content associated with the query-refinement advertisement 416 may be provided partially by the company and partially by an advertisement search service such as the advertisement search service 210 of FIG. 2. Any and all such variations, and any combination thereof, are contemplated to be within the scope of embodiments of the present invention.

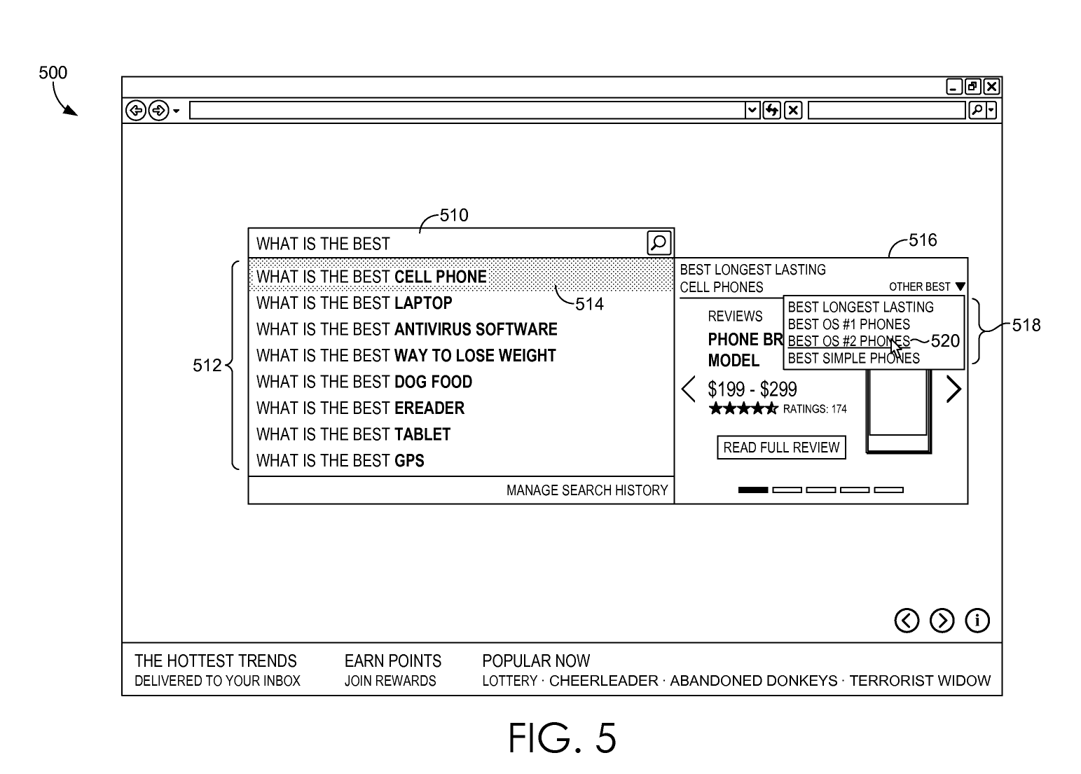

Turning to FIG. 5, the search page 400 (now labeled as search page 500) is shown at a still later point in time. The search page 500 includes a query-input region 510 corresponding to the query-input region 410 of FIG. 4, a set of query-completion suggestions 512 corresponding to the set of query-completion suggestions 412 of FIG. 4, a query-completion suggestion 514 corresponding to the query-completion suggestion 414 of FIG. 4, and a query-refinement advertisement 516 corresponding to the query-refinement advertisement 416 of FIG. 4.

The query-refinement advertisement 516 illustrates the presentation of additional query-refinement suggestions 518 provided upon selection of, for example, the option 420 of FIG. 4. The additional query-refinement suggestions 518 further refine the query-completion suggestion 514. Selection of, for example, query-refinement suggestion 520 may initiate the presentation of additional query-refinement suggestions or may navigate the user to a landing page that provides content directed to the selected suggestion 520. Any and all such variations, and any combination thereof, are contemplated to be within the scope of embodiments of the present invention.

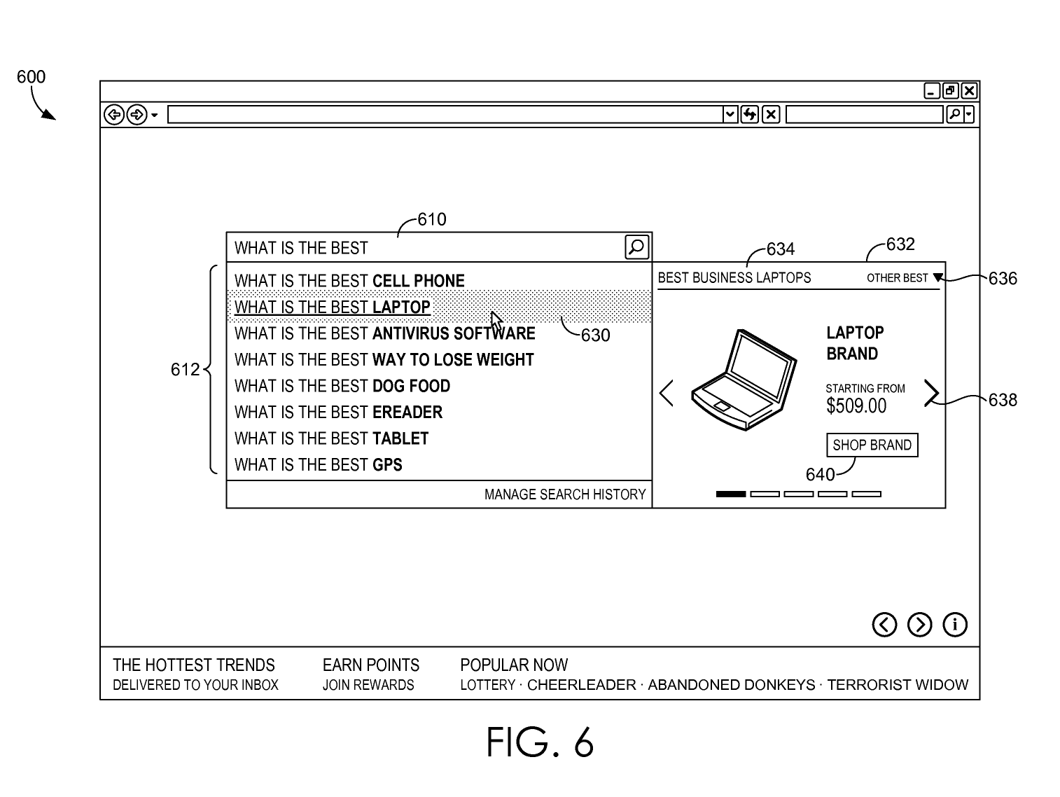

With respect to FIG. 6, FIG. 6 illustrates the search page 500 (now labeled as search page 600) and includes a query-input region 610 corresponding to the query-input region 510 of FIG. 5, and a set of query-completion suggestions 612 corresponding to the set of query-completion suggestions 512 of FIG. 5. As shown, a user is interacting with query-completion suggestion 630. The interaction may include the user selecting the query-completion suggestion 630, hovering over or placing a cursor on the query-completion suggestion 630, and/or interacting with the query-completion suggestion 630 by using one or more gestures.

In response to the interaction with the query-completion suggestion 630, a query-refinement advertisement 632 is presented in association with the query-input region 610. The query-refinement advertisement 632 is relevant or related to the query-completion suggestion 630 (e.g., the query-completion suggestion 630 is directed to laptop computers and the query-refinement advertisement 632 is directed to laptop computers). The query-refinement advertisement 632 includes a first query-refinement suggestion 634 that helps to further refine the query-completion suggestion 630. The query-refinement advertisement 632 further includes an option 636 to present additional query-refinement suggestions, an option 638 to view additional products corresponding to the first query-refinement suggestion 634, and an action 640 (e.g., “Shop Thinkpad”) that, when selected, navigates the user to a landing page relevant to the action 640.

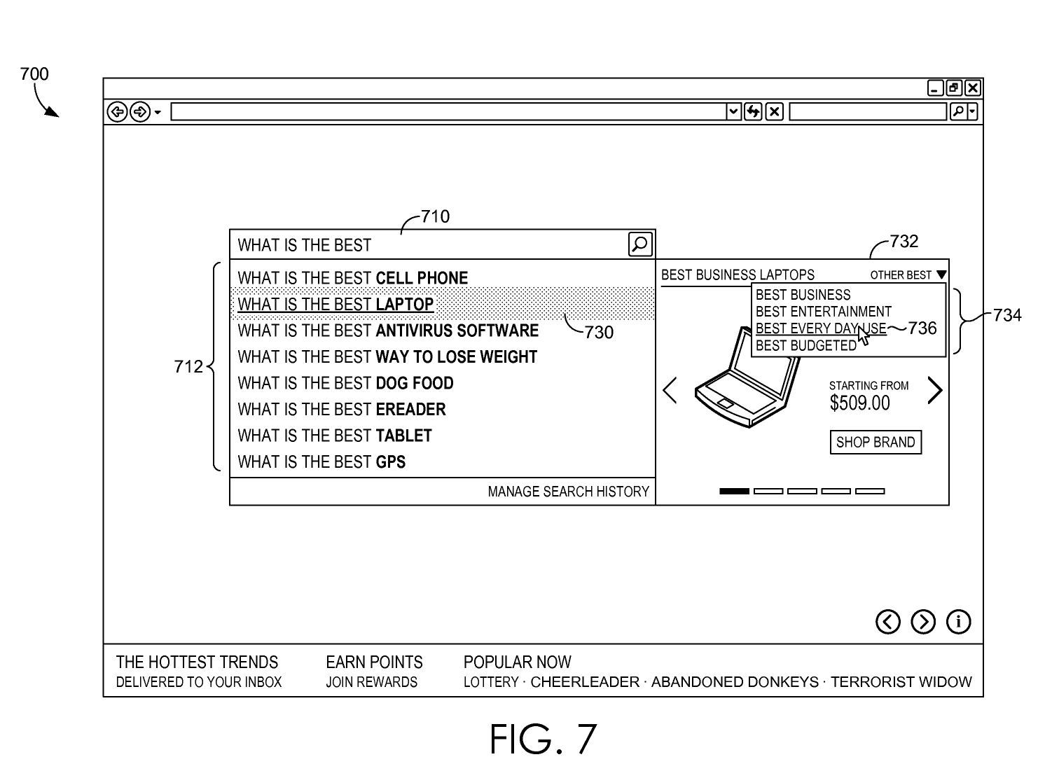

FIG. 7 depicts the search page 600 (now labeled as search page 700) at a later point in time. The search page 700 includes query-input region 710 corresponding to the query-input region 610 of FIG. 6, a set of query-completion suggestions 712 corresponding to the set of query-completion suggestions 612 of FIG. 6, query-completion suggestion 730 corresponding to the query-completion suggestion 630 of FIG. 6, and a query-refinement advertisement 732 corresponding to the query-refinement advertisement 632 of FIG. 6.

The query-refinement advertisement 732 illustrates the presentation of additional query-refinement suggestions 734 provided in response to, for example, selection of the option 636 of FIG. 6. The query-refinement suggestions 734 further refine the query-completion suggestion 730. Selection of a query-refinement suggestion such as query-refinement suggestion 736 may navigate a user to a landing page with content relevant to the query-refinement suggestion 736 or may initiate the presentation of additional query-refinement suggestions.

The presentation of different query-refinement advertisements, such as the query-refinement advertisement 732 and the query-refinement advertisement 516, corresponding to respectively the query-completion suggestion 730 and the query-completion suggestion 514, occurs simultaneously with the user interacting with the respective query-completion suggestion. Thus, for instance, as a user interacts with each query-completion suggestion by, for example, running his or her cursor over the query-completion suggestion, query-refinement advertisements rapidly appear and disappear. If the user pauses on a particular query-completion suggestion, the associated query-refinement advertisement persists on the display. As well, the query-refinement advertisement persists if the user interacts with the advertisement. In one aspect, one query-refinement advertisement is presented at a time to help narrow the user's focus.

In each of the cases described above, the query-refinement advertisements are presented on an initial search page and are presented before any search results are shown. Additionally, as shown, the query-refinement advertisements are presented in association with or adjacent to the query-input region of the search page. Presenting query-refinement advertisements before presenting search results and presenting query-refinement advertisements in association with a query-input region on a search page helps to increase user responsiveness to the advertisements.

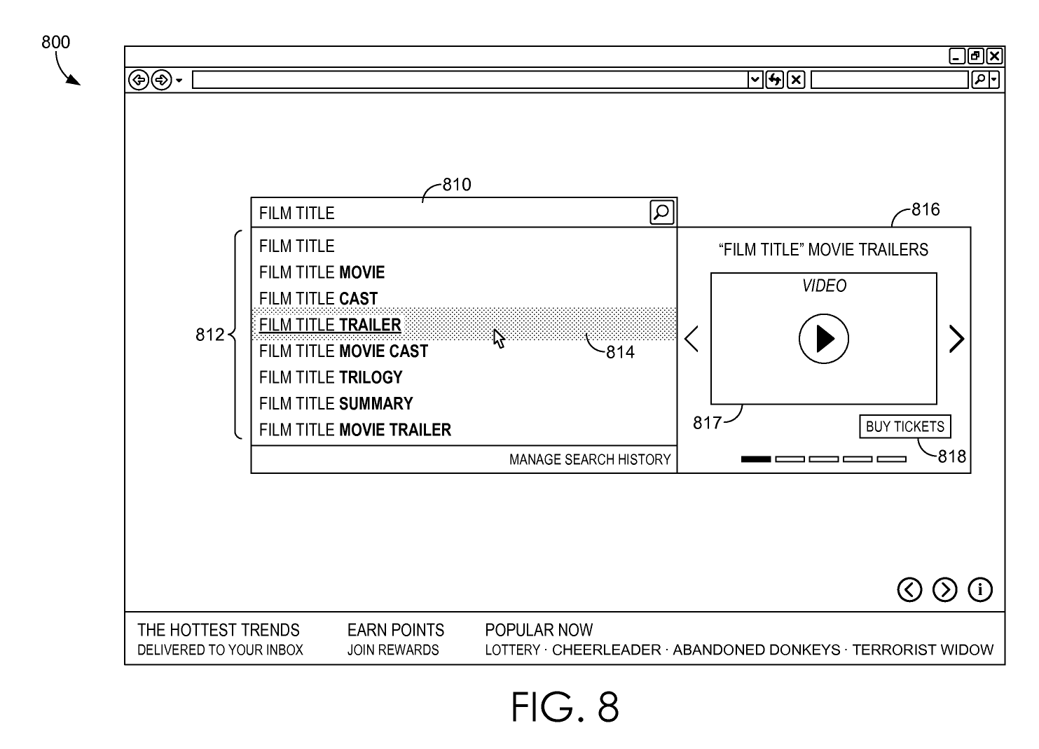

FIG. 8 depicts yet another exemplary search page 800. The search page 800 includes a query-input region 810 with the search query “hunger games,” a set of query-completion suggestions 812, a query-completion suggestion 814 that is receiving a user interaction, and a query-refinement advertisement 816. The query-refinement advertisement 816 includes content that meets the user's intent as shown by the query-completion suggestion 814. For example, the query-refinement advertisement 816 includes a trailer 817 that can be played while the user remains on the search page 800. Additionally, the query-refinement advertisement 816 includes a selectable action 818, “Buy tickets.” Selection of the action 818 may automatically initiate the action of buying tickets without navigating the user away from the search page 800. Selecting the trailer 817 and/or the action 818 helps to meet the user's intent without ever having to execute a search using the inputted search query.

The manner of presenting query-refinement advertisements and query-refinement suggestions as illustrated in, for instance, FIGS. 4-8 is meant to be illustrative and not limiting in any way. Query-refinement advertisements and suggestions may be presented in a number of different ways without departing from the spirit and scope of the described invention.

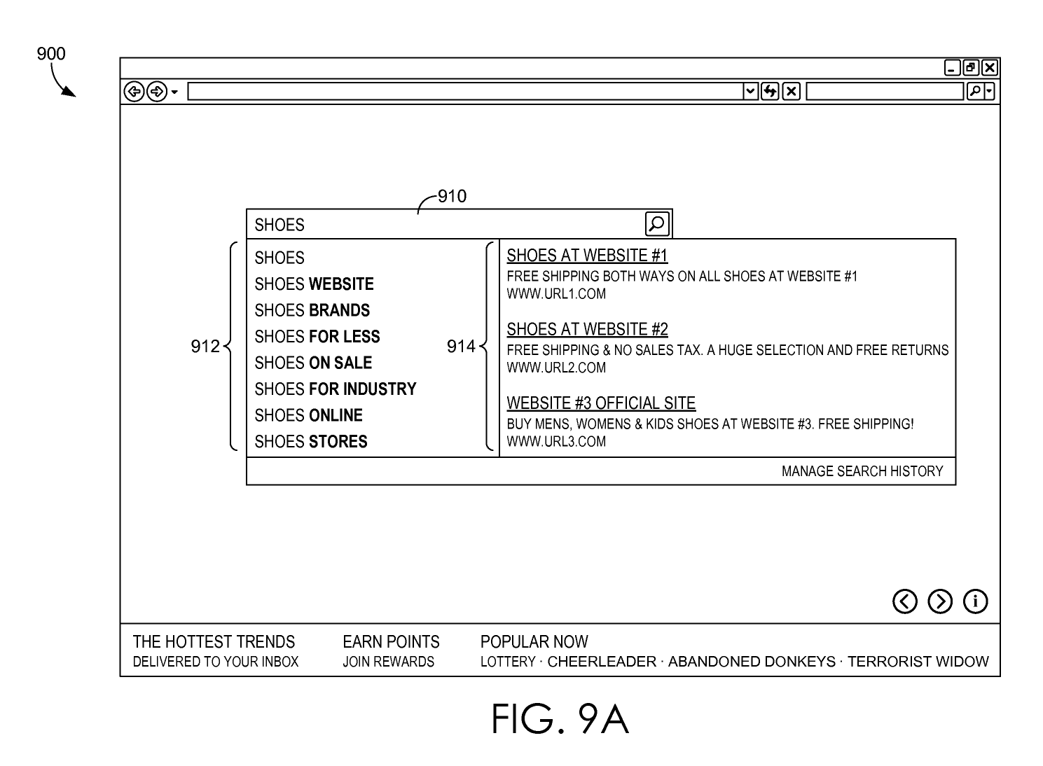

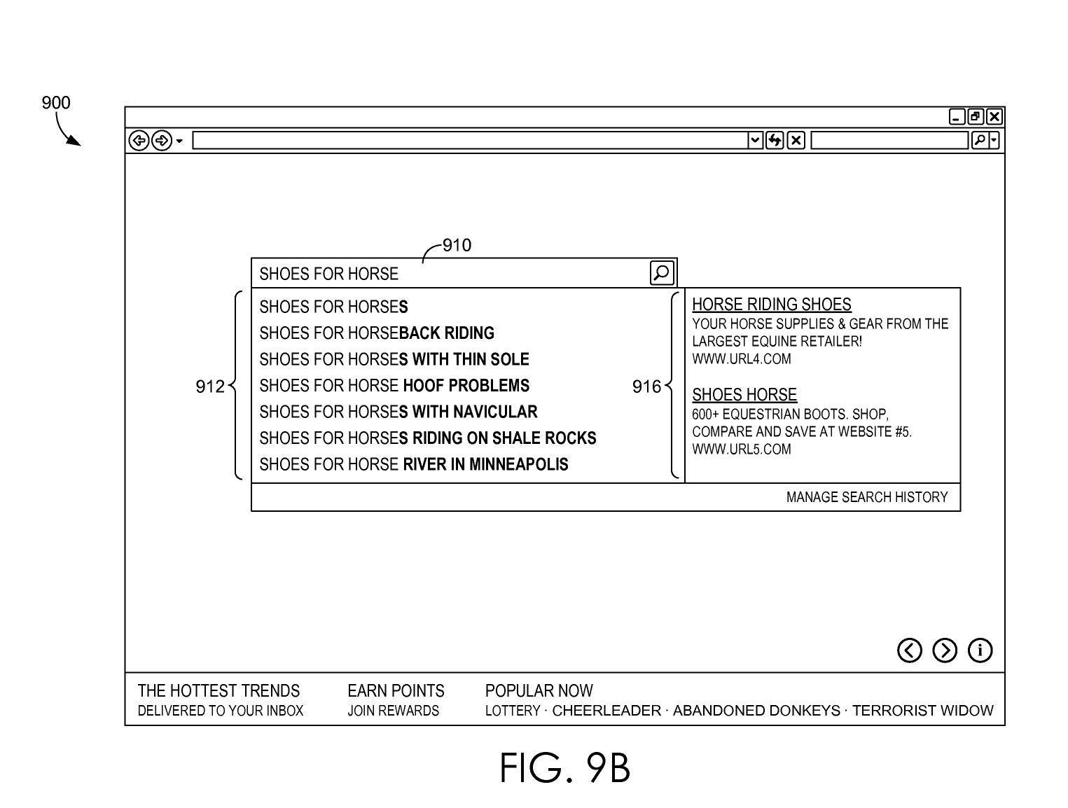

FIGS. 9A and 9B illustrate an alternative way of presenting advertisements that answer user intent as shown by an inputted search query or a query-completion suggestion. Both FIGS. 9A and 9B include a search page 900, a query-input region 910, a set of query-completion suggestions 912, a first set of query-related advertisements 914, and a second set of query-related advertisements 916. The advertisements 914 update to the advertisements 916 as the user continues to enter additional characters and/or query terms into the query-input region 910. For example, the advertisements 914 presented in FIG. 9A relate generally to the inputted search query “shoes.” However, the advertisements 916 presented in FIG. 9B relate generally to the inputted search query “shoes for horses.” Although the advertisements 914 and 916 are shown as relating generally to the search query, it is contemplated that the advertisements 914 and 916 may also relate to a query-completion suggestion using methods described above. Further, the presentation of the advertisements 914 and 916 in association with the query-input region 910 on an initial search page and the presentation of the advertisements 914 and 916 before search results are shown both help to increase user responsiveness to the advertisements. The manner of presenting the advertisements 914 and 916 as illustrated in, for instance, FIGS. 9A-9B is meant to be illustrative and not limiting in any way. The advertisement 914 and 916 may be presented in a number of different ways without departing from the spirit and scope of the described invention.

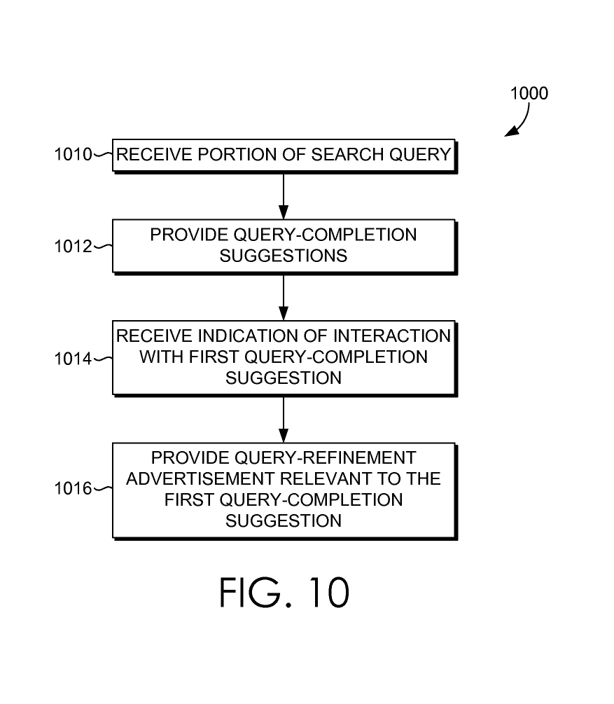

FIG. 10 depicts a flow diagram of an exemplary method 1000 of providing query-refinement advertisements based on query-completion suggestions. At a step 1010, at least a portion of a search query is received by a receiving component such as the receiving component 222 of FIG. 2. The portion of the search query may comprise one or more characters or letters, words, and/or phrases and may be inputted into a query-input region of a search page associated with, for example, an Internet search engine, a Web browser, and/or a third-party application.

At a step 1012, one or more query-completion suggestions are provided by a query-completion suggestion component such as the query-completion suggestion component 224 of FIG. 2. The query-completion suggestions may be provided utilizing methods known in the art. In one aspect, the query-completion suggestions are provided in association with or adjacent to the query-input region on the display screen.

At a step 1014, an indication of interaction with one of the query-completion suggestions is received by, for example, the receiving component. Interactions may include the selection of a query-completion suggestion, hovering over a query-completion suggestion, placing a cursor on top of a query-completion suggestion, interacting with a query-completion suggestion using gestures such as tapping, swiping, or sliding, and other interactions that indicate an interest in the query-completion suggestion.

At a step 1016, and in response to the interaction with the query-completion suggestion, a query-refinement advertisement is provided by an advertisement-selection component such as the advertisement-selection component 226 of FIG. 2. The query-refinement advertisement is related to query-completion suggestion receiving user interaction and may be provided in association with the query-input region. And, as well, the query-refinement advertisement may be presented before any search results are returned to the user. The query-refinement advertisement may be sponsored by a third-party such as a company that sells products or services or an advertising agency that works in conjunction with a company to promote the sale of products or services.

The query-refinement advertisement may comprise at least one or more query-refinement suggestions that help the user to refine his or her search. The query-refinement advertisement and its associated query-refinement suggestions are relevent to the query-completion suggestion that is receiving the interaction. The query-refinement suggestions may be provided by the company that is sponsoring the advertisement and may be based on a decision tree. The suggestions may be presented as links, the selection of which navigates the user to a landing page that is relevant to the selected link. Additionally, selection of a query-refinement suggestion may initiate the presentation of additional query-refinement selections. The query-refinement advertisement may also include one or more selectable actions that, when selected, automatically initiate the action or navigate the user to a landing page that is relevant to the action. This may occur without a search utilizing the search query needing to be executed.

The method 1000 may further comprise receiving an indication of interaction with a second query-completion suggestion provided in response to the inputted portion of the search query. In response to the interaction, a second query-refinement advertisement is presented in association with, for example, the query-input region. The second query-refinement advertisement may comprise one or more query-refinement suggestions relevant to the second query-completion suggestion. In one aspect, once the second query-refinement advertisement is presented, the first query-refinement advertisement is no longer presented.

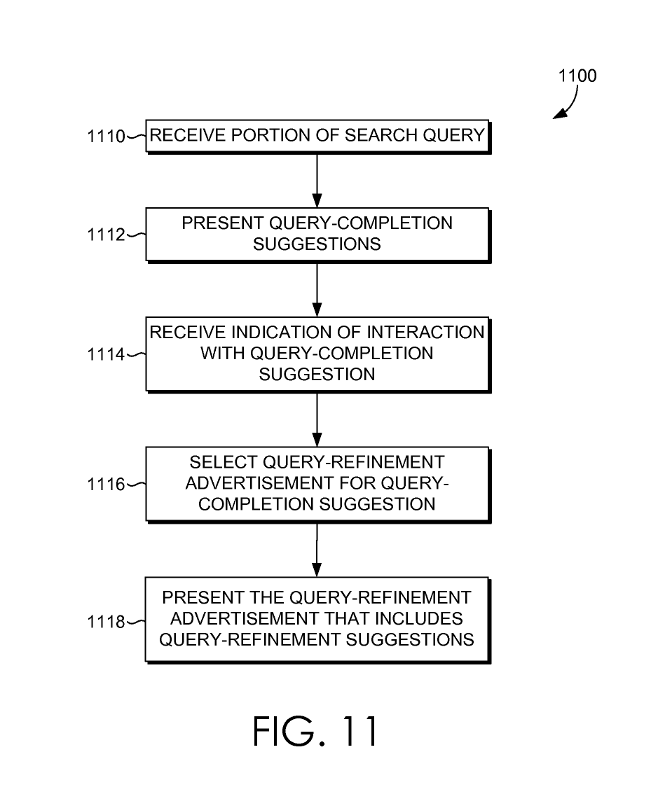

FIG. 11 depicts another flow diagram illustrating an exemplary method 1100 of providing query-refinement advertisements based on query-completion suggestions. At a step 1110, at least a portion of a search query is received; the search query is inputted at a query-input region associated with, for example, a search page. Exemplary search pages may include a search engine page, an Internet browser page, a third-party application page, and the like. At a step 1112, at least one query-completion suggestion is presented in association with the query-input region. The query-completion suggestion is based on the inputted search.

At a step 1114, an indication of interaction with the query-completion suggestion is received, and, at a step 1116, a query-refinement advertisement is selected. The query-refinement advertisement may be sponsored by a third party and may be selected based on a number of factors. Selection may be based on keywords associated with the query-completion suggestion, a geographical location associated with the user who inputted the search query, a cached search history, user profile information, social network information associated with the user, and the like.

At a step 1118, the query-refinement advertisement is presented in association with the query-input region. The query-refinement advertisement includes one or more query-refinement suggestions that help to further refine the query-completion suggestion. The query-refinement suggestions may be presented to a user via a drop-down list. The query-refinement advertisement may also include selectable actions relevant to the query-completion suggestion.

The method 1100 may further include receiving a selection of one of the selectable actions associated with the query-refinement advertisement; the selection may be received by a navigation component such as the navigation component 228 of FIG. 2. Selection of a selectable action may navigate a user to a landing page that enables the user to initiate and/or complete the action. Alternatively, selection of a selectable action may automatically, and without human intervention, initiate the action without navigating away from the query-input region of the display screen. The method 1100 may further comprise receiving a selection of one of the query-refinement suggestions and navigating the user to a landing page having content relevant to the selected query-refinement suggestion.

The present invention has been described in relation to particular embodiments, which are intended in all respects to be illustrative rather than restrictive. Alternative embodiments will become apparent to those of ordinary skill in the art to which the present invention pertains without departing from its scope.

What is claimed is:

1. One or more computer-storage media having computer-executable instructions embodied thereon that, when executed by a computing device, cause the computing device to perform a method of providing query-refinement advertisements based on query-completion suggestions, the method comprising:
receiving at least a portion of a search query;
providing one or more query-completion suggestions based on the at least the portion of the search query;
receiving an indication of interaction with a first query-completion suggestion of the one or more query-completion suggestions; and
in response to the interaction with the first query-completion suggestion, providing a first query-refinement advertisement relevant to the first query-completion suggestion.

2. The media of claim 1, wherein the first query-refinement advertisement comprises at least one or more query refinement suggestions relevant to the first query-completion suggestion.

3. The media of claim 2, wherein the first query-refinement advertisement is sponsored by a third party, and wherein the third party provides the one or more one or more query-refinement suggestions.

4. The media of claim 3, wherein the third party comprises at least one of a company that sells a product or service that is the subject of the first query-refinement advertisement, or a third-party agency that works in conjunction with the company to promote the sale of the product or service.

5. The media of claim 4, wherein each of the one or more query-refinement suggestions is associated with a selectable link.

6. The media of claim 5, further comprising:
receiving a selection of a selectable link associated with one of the one or more query-refinement suggestions; and
navigating to a landing page associated with the third party.

7. The media of claim 1, further comprising:
receiving an indication of interaction with a second query-completion suggestion of the one or more query-completion suggestions; and
in response to the interaction with the second query-completion suggestion, providing a second query-refinement advertisement relevant to the second query-completion suggestion.

8. The media of claim 7, further comprising in response to providing the second query-refinement advertisement, no longer providing the first query-refinement advertisement.

9. The media of claim 1, wherein the indication of interaction comprises at least one of a selection of the first query-completion suggestion, a gesture involving the first query-completion suggestion, hovering over the first query-completion suggestion, or placing a cursor on the first query-completion suggestion.

10. The media of claim 1, wherein the one or more query-completion suggestions and the first query-refinement advertisement are provided in association with a query-input region of a display screen, the query-input region receiving the at least the portion of the search query.

11. The media of claim 1, wherein the first query-refinement advertisement is provided prior to presentation of search results related to the at least the portion of the search query or the first query-completion suggestion.

12. A system for providing query-refinement advertisements based on query-completion suggestions, the system comprising:
a computing device associated with an advertisement search service having one or more processors and one or more computer-storage media; and
a data store coupled with the advertisement search service,
wherein the advertisement search service:
receives at least a portion of a search query in association with a query-input region of a screen display;
provides at least one query-completion suggestion in association with the query-input region, the at least one query-completion suggestion based on the at least the portion of the search query;
receives an indication of interaction with the at least one query-completion suggestion; and
based on the interaction, provides a query-refinement advertisement in association with the query-input region, the query-refinement advertisement relevant to the at least one query-completion suggestion.

13. The system of claim 12, wherein the query-refinement advertisement is stored in association with the data store.

14. The system of claim 13, further comprising:
further wherein the advertisement search service:
subsequent to providing the query-refinement advertisement in association with the query-input region, executes a search based on at least one of the at least the portion of the search query or the at least one query-completion suggestion; and
presents search results on a results page.

15. A computerized method carried out by an advertisement search service having at least one processor for providing query-refinement advertisements relevant to query-completion suggestions, the method comprising:
receiving at least a portion of a search query in association with a query-input region of a display screen;
presenting at least one query-completion suggestion in association with the query-input region, the at least one query-completion suggestion based on the at least the portion of the search query;
receiving an indication of interaction with the at least one query-completion suggestion;
selecting, using the at least one processor, at least one query-refinement advertisement; and
presenting the at least one query-refinement advertisement in association with the query-input region, the at least one query-refinement advertisement comprising one or more query refinement suggestions relevant to the at least one query-completion suggestion.

16. The method of claim 15, wherein selecting the at least one query-refinement advertisement comprises one or more selected from the following:
(A) selecting the at least one query-refinement advertisement based on one or more keywords in the at least one query-completion suggestion,
(B) selecting the at least one query-refinement advertisement based on a geographical location associated with a user who inputted the at least the portion of the search query,
(C) selecting the at least one query-refinement advertisement based on a cached search history,
(D) selecting the at least one query-refinement advertisement based on user profile information, or
(E) selecting the at least one query-refinement advertisement based on social network information associated with the user.

17. The method of claim 15, wherein the at least one query-refinement advertisement further comprises one or more selectable actions relevant to the at least one query-completion suggestion

18. The method of claim 17, further comprising:
receiving a selection of at least one of the one or more selectable actions relevant to the at least one query-completion suggestion; and
navigating a user to a landing page enabling completion of the action.

19. The method of claim 17, further comprising:
receiving a selection of at least one of the one or more selectable actions relevant to the at least one query-completion suggestion; and
automatically initiating the action without navigating away from the query-input region of the display screen.

20. The method of claim 15, further comprising:
receiving a selection of at least one of the one or more query-refinement suggestions; and
navigating a user to a landing page having content relevant to the at least one of the one or more query-refinement suggestions.
